(19) United States
(12) Patent Application Publication
(10) Pub. No.: US 2004/0108981 A1
(43) Pub. Date: Jun. 10, 2004

(54) Novel mobile audio visual system for managing the information

(76) Inventors: Atika El Sayed, Levallois-Perret (FR); Nicolas Paris, Nanterre (FR)

Correspondence Address: MUSERLIAN AND LUCAS AND MERCANTI, LLP, 475 PARK AVENUE SOUTH, NEW YORK, NY, 10016, US

(21) Appl. No.: 10/336,699

(22) Filed: Jan. 3, 2003

(30) Foreign Application Priority Data
Dec. 10, 2002 (FR) 02 15593

(51) Int. Cl. G09G 3/30; G09G 5/00

(52) U.S. Cl. 345/80; 345/8

(57) ABSTRACT

This invention relates to the field of optical and more precisely to the field of visualization by means of electronic systems.

It has precisely as an object an electronical device integrated in a pair of spectacles which allows to the bearer to receive and to emit visual information superimposed to his visual field through a miniaturized screen and an optical device incorporated in one of the side-pieces of the spectacles, while receiving and emitting sound information through the auditory sub-system.

The system according to the invention may be used in an environment intended for professional and for general public for the reproduction or capture of visual and sound information.

This invention relates to the domain of optics and more particularly to the field of visualization by means of electronic systems.

It has more particularly as an object the integration of an optical and audio-portable device which allows to an user to receive and to emit images and sounds while keeping visualization and hearing of the surroundings.

It has precisely as a subject an electronic device incorporated in spectacles which allows to the bearer to receive and to emit visual information super-imposed to his optical field though a miniaturized screen, an optical device incorporated in one of the side-pieces of the spectacles while receiving and emitting sound information through the auditive sub-system.

The images are perceived through an electronic micro screen incorporated into the system just in front of an eye of the user and which may be fed by any video image generator.

The seized images which are sent by a micro-camera integrated into the system, may be displayed on a micro screen or resent to a video annex system.

The audio device is constituted by a receiving system and a system of sound capture.

They were been already known some compact amovible display devices intended to be mounted on the head, preferably, by use of head phones or a side portion of spectacles, which provides an image stemming form a display of image superimposed to an existing image (deed EP-A 1027.626). This kind of assembly use electronic imaging and involves an optical tube containing a reflecting area. This ensemble presents a significant volume which may at least disturb the visual field of the user, or endow him with a less aesthetic aspect.

The present invention has thus as an object to miniaturize such device and to insure it a more clothing than technical aspect, together with the incorporation of largely superior optical and sounding results.

The optical system according to the invention is compact and integrates itself in a pair of spectacles, while forming an inseparable and indissociable whole, which allows to the bearer of such spectacles the visualization and acquisition of various information, which become displayed in his field of signal.

These spectacles may besides keep their own function, such as correction and protection. To this bi-directional visual function it may be added an audio system which also allows to receive and capture information. The optical system which serves as a vehicle for the image may also be integrated to a broad variety of various supports; masks, headphones, telescopes, in order to give the user the benefit of a virtual image floating in his field of vision.

The present invention then uses the system “see around” in which the dispatched image comes to be placed on a more or less significant part of the field of vision.

This system is the more simple and may also be immediately exploited in view of the foreseen application and the presently available technology.

The principle of this invention consists in providing to the user the benefits of these systems “see around” while getting over the present limitation of the existing systems: accumulation, weight, aesthetics by the integration to the most suitable support, the best accepted support by the user, in a pair of spectacles.

This invention may be more precisely defined by the presently preferred modes of performance. The invention includes:

a system allowing the display of a pair of spectacles which may be of various forms or sizes,

a system allowing the visualization of information in the visual field of the user trough a miniaturized screen and optical system reflecting an image to the eyes of the user, thus arising the illusion of a virtual screen floating in the field of vision of the user

the system of visualization may be monocular or binocular and this do not markedly obstruct the field of vision of the user

it also includes an opto-electronic system which is an integral part of the structure of the spectacles

a reversible system which may be positioned in the right side or on the left side of the frame

a system which allow to get further additive information thanks a microphone

a system which allow to record the visual information thanks a micro-camera

a system which allows the user to position the virtual screen at several locations in his field of vision at the horizontal, vertical or in depth planes.

a system which allows to use the spectacles for its classical functions i.e. visual correction, visual protection (sun, dust . . .)

a system which has to be connected to a central unit to receive the information.

This central unit may take several forms: computers of every type (desk computer, portable computers, clothing computers, personal assistant . . . ), video apparatus (television, magnetos cops, DVD, camera, multimedia recorders . . . ), photographic apparatus, recorders . . .

This central unit may be located at a determined position or be worn by the user (in a rucksack, at the belt, or incorporated in a garment).

Definitively it is a matter of a system intended to be autonomous and functioning with its own sources of energy, such as a chemical battery or a solar cell.

Conveniently the optical system according to the invention is namely constituted of

an optical pathway integrated in to the structure of the spectacles and allowing to receive an emission of light from the source of images and to convey it until the eye of the user, these optics being constituted of a mirror, a pathway relying to a seric of two optics directed towards the eye of the user and including a prism which helps to straighten the signal of light emitted by the source.

The optical pathway is used to convey the signal towords the optics

The optics are useful to enlarge the signal, to correct it, and to direct it to the pupil of the user.

The source of light includes a plane screen with liquid crystalls or any other screen avaible, using another technology.

the visual source is made of a module for retrolighting, allowing to produce a light source (as it is in the case of LCD, screen)

The visual source is coupled to an electronic system allowing to produce the display of information on the screen and or the retrolighting of it.

a system allowing the diffusion of sounding information through a loud-speaker intended to be worn in or near of ear.

The visual source may be constituted on the focal level, through a device letting one of the prisms move with respect to the remainder of the system which remains fixed.

a system allowing the recording of visual information thanks a micro-camera located on the opposite side part of the optical system.

the systems of sounding, recording and/or restoration may be integrated into the spectacles or may be also go to add itself to the frame of the spectacles in an optional fashion.

the optical assembly, the visual source and the whole or part of the associated electronics are located un the sidepiece of the spectacles, in a perfectly independent manner of the face of them.

The electronic modules incorporated in a side-part of the spectacles are connected to complementary electronic modules or to the source of information by filar way or non-filar way. The whole is then constituted with a housing incorporating the electronic modules (conversion of the signal, processing of the signal) connected to the pair of spectacles through filar or non-filar. This module may also integrate the control of adjustment of the display (lightening, contrast and other regulation). These regulating may also be swerved.

the housing may also be connected to the spectacles through of a wireless system allowing exchange information between the various electronic components fixed on the spectacles and the electronic components of the box.

The box may contain an autonomous feeding device useful for producing the functioning of the electronic component contained therein and those of the spectacles.

The visualization system is bound on a part of the head of the user due to its integration to a pair of spectacles, this systems includes

a frame easy to be held on the face of the user

One or several screens which allows a correction of the sight and/or a protection against the sun

the side-pieces bound to the frame and lying on the ears of the user, one at least of these side pieces incorporating the optical system thus described as well as any part or the whole of the electronic module, through a case developed for this purpose

This case is equipped with a movable system insuring the displacement in the sense of width, height and depth in order to allow the control of the optical system and the source of light with respect to the eye of the user.

The thus formed whole allows to the user to visualize information stemming for an external source according to an identified mode:

a screen floating before his eyes (right or left or both) located from 15° of field of external vision (from the pupil) and which may be displaced up to 30 to 40°, in order to respect the usable field of sight (this one which is useful to the area of sight “of work” and a so-called normal rotation of the eye (0-15°)

The device may also be regulated on the vertical plane in a field of 15° below and above the sight field of the eye.

The display device many also be regulated in evelation and in azimuth (ie in the vertical and horizontal planes) as well as in its depth.

The system according to this invention may also be used in an environment intended for the professionals and to the general public.

1—The domains of applications:

industrial (industrial processing, quality control, logistics, maintenance)

medical imaging

automobils

safety

marine

museums

exhibitions

general public

assistance to motor disabled people

2—The uses:

[symbol] reception of information

display of text: proceeding, orders, mailing, notebook, information on organisations, SMS, meetings, tasks, agendums

display of schemas: planning of orders, graphic schemas, technical systems of reference, route charts

display of images: medical imaging, photos books, Tables, internet, on line orders, documentary search, television

video displays: webcams, movies, duplication of displays from several cameras, recognition of faces, GPS, video conference

[symbol] Data capture:

Recognition of the voice, validation of proceedings of controls by the voice

Track ball, keyboard, bar code reader, validation of texts, of menus, of parcels, of deliveries of orders, of selections by a text, or traffic in rolling menus.

Video: recording of somewhat, somebody is visualizing thanks to the camera intended for the security of a building, of a location for holidays, of a house, of a piece of theater.

Audio: recording of something somebody hears or of the sound that somebody emits, thanks to the microphone, to keep in memory the information such as a phone dial, music, sounds

This invention will be more precisely defined through the herein annexed drawings which show the various modalities of achievement

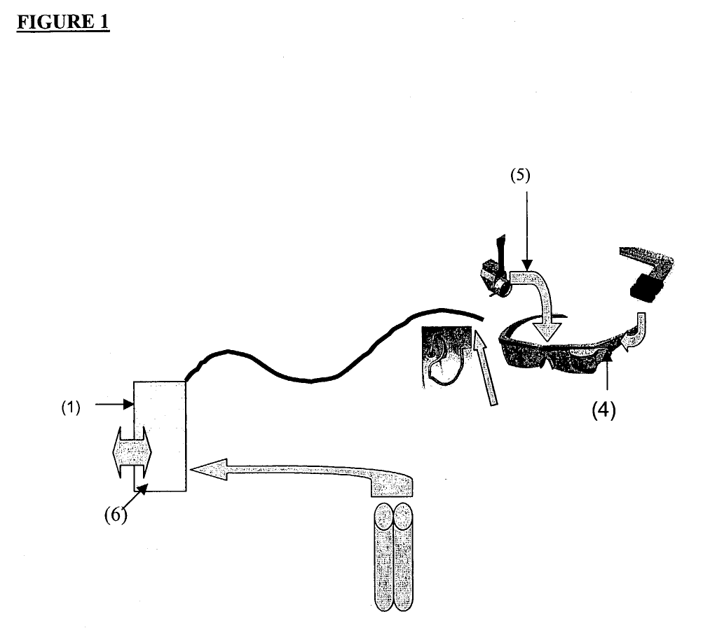

FIG. 1. Provides a general scheme of utilization of the device according to the invention. It includes some connections of exchange of information (1) with outside system (non figurated) a connexion, a micro head-phone (2), a micro-camera (3), a pair of spectacles (4) including the module of display (5).

The connections are located in a housing (6) fed by a source of energy (battery or electric battery).

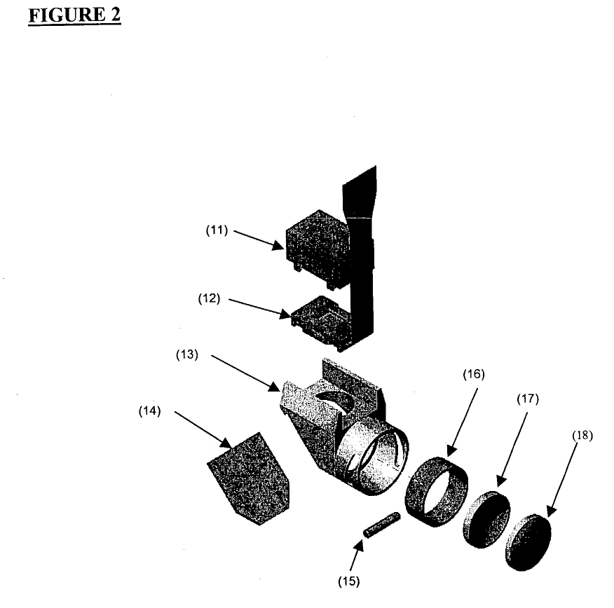

FIG. 2 Shows in broken up sights, the opto-electronic system of the display module borne by a side-piece of the spectacles. It includes a light source (11), a microdisplay (12), a main handle (15) to control the localisation, a cell for lens (16), spherical lens (17) and spherical lens (18).

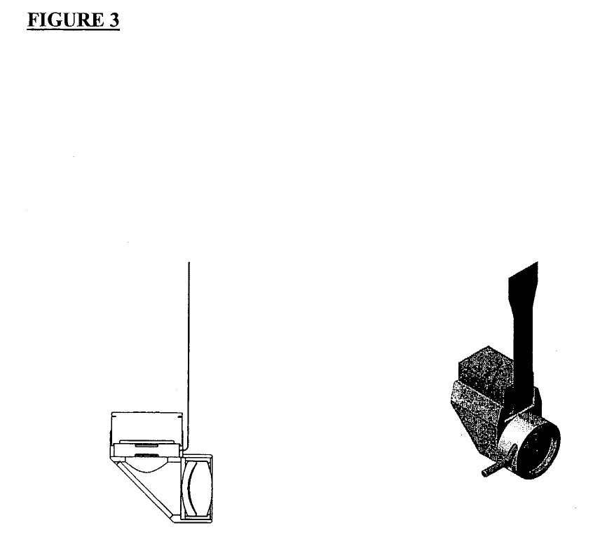

FIG. 3 Shows the opto-electronic system of this invention in schematic view and its disposition on or in a housing.

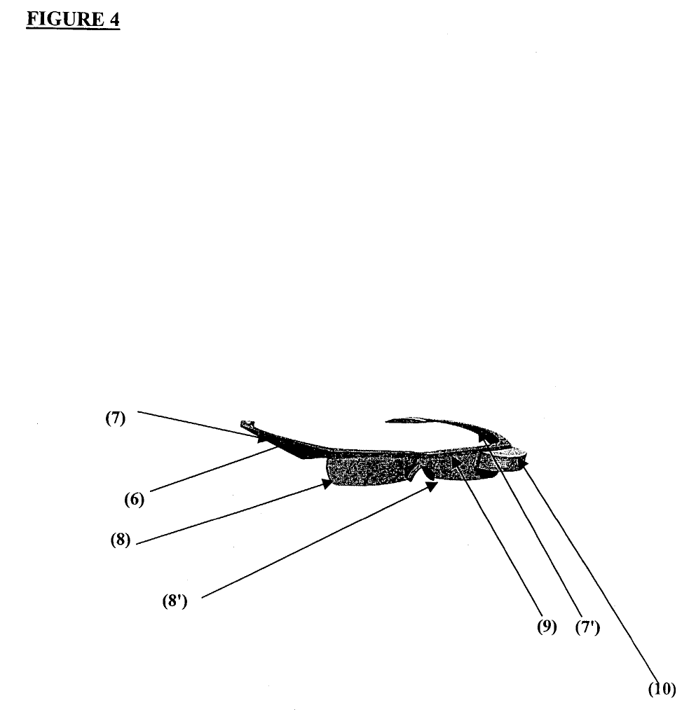

FIG. 4 Shows the device according to this invention including a pair of spectacles, the electronic device and the micro camera mounted on the external rims of the spectacles. In this way the user may perceive the actual image and the image transmitted without deformation and without delay of dispatch. By integrating the micro camera, the user may also put on film that he is seeing.

This figure also shows the pair of spectacle (6) including two incurvated, slightly flattened, side-pieces (7) (7′), two glasses for the natural sight (8), (8′) and on one glass affixed on the rim of the transversal frame (9), the electronic housing (10).

What is claimed is:

1. New electronic device integrated in spectacles characterized in that it allows the bearer to receive and to emit visual information in superimposition of his field of slight through a miniaturized screen and an optical device mounted on one of the side-piece of spectacles, and simultaneously receive and/or emit sounding information by the auditory sub-system.

2. Electronic device according to claim 1, wherein the images are perceived through an electronical micro-screen.

3. Electronic device according to claim 1 or claim 2, wherein the electronic micro-screen is integrated into the system and is located just before the eye of the user.

4. Electronic device screen according to one of claims 1 to 3, wherein the images seized by the micro-camera are returned back to an annex video system.

5. Electronic device according to one of the claim 1 to 4, wherein the sounding information, is received in an audio device constituted by a sounding and capturing system.

6. Electronic device according to one of the preceding claims characterized in that it includes a system allowing a pair of spectacles to be presented in various forms and various sizes, a monocular or binocular system for visualizing the images, an opto-electronic system which is an integral part of the same of the spectacles.

7. Electronic device according to one of the preceding claims, characterized in that its includes a system which allows the user to position the visual screen in the horizontal, vertical and in depth plane.

8. Electronic device according to one of the preceding claims characterized in that it is connected to a central unit able to receive the information, selected from the group consisting of computers, video apparatuses, cameras and recorders.

9. Electronic device according to one of the preceding claims, characterized in that it is constituted of an optical path-way integrated in to the frame of spectacles and allows to receive a light emission, formed of two optics directed to wards the eye of the user and which includes a prism used to strengthen the light signal emitted by the light source, towards the optics.

10. Electronic device according to claim 9 characterized in that the side piece of the spectacles incorporates one or several electronic modelus constituted of a housing incorporating a nonfilar or filarway control for regulating the display and a device of feeding.

11. Utilization of an electronic device according to claims 1 to 10, for medical imaging, in the automobile industry, in the safety devices, in the assistance for motor disabled people, for displaying images, text or information.
